(19) United States
(12) Patent Application Publication
(10) Pub. No.: US 2008/0146850 A1
(43) Pub. Date: Jun. 19, 2008

(54) Method for Producing Tertiary Phosphines

(75) Inventors: Kathrin Wissel, Hanau (DE); Matthias Maase, Speyer (DE); Oliver Huttenloch, Ispringen (DE); Toni Flajs, Mutterstadt (DE); Melanie Kuhl, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/815,460

(22) PCT Filed: Feb. 9, 2006
(86) PCT No.: PCT/EP06/50808

§ 371 Date: Aug. 3, 2007

(30) Foreign Application Priority Data
Feb. 10, 2005 (DE) 102005005946.5

(51) Int. Cl. C07F 9/50

(52) U.S. Cl. 568/17

(57) ABSTRACT

Method for producing tertiary phosphines by reacting a compound of the general formula (I)

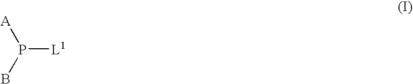

in which
A is R¹ or L²,
B is R² or L³,
the R¹ and R² radicals are each independently an organic radical having in each case from 1 to 30 carbon atoms, where the R¹ and R² radicals may also be joined together; and
the leaving groups L¹ to L³ are each independently halogen, alkyloxy having from 1 to 10 carbon atoms or aryloxy having from 6 to 10 carbon atoms
(a) with an alkali metal in an organic aprotic solvent and
(b) a compound of the general formula (II)

L⁴-R³ (II)

in which
the R³ radical is an organic radical having in each case from 1 to 30 carbon atoms; and
the leaving group L⁴ is halogen, alkyloxy having from 1 to 10 carbon atoms or aryloxy having from 6 to 10 carbon atoms,
   in which the resulting reaction mixture is hydrolyzed with an aqueous base which has a pH of ≧10 and the organic phase is removed from the aqueous phase.

Process for preparing tertiary phosphines by reacting a compound of the general formula (I)

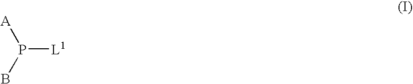

in which
A is R¹ or L²,
B is R² or L³,
the R¹ and R² radicals are each independently an organic radical having in each case from 1 to 30 carbon atoms, where the R¹ and R² radicals may also be joined together; and
the leaving groups L¹ to L³ are each independently halogen, alkyloxy having from 1 to 10 carbon atoms or aryloxy having from 6 to 10 carbon atoms
(a) with an alkali metal in an organic aprotic solvent and
(b) a compound of the general formula (II)

L⁴-R³ (II)

in which
the R³ radical is an organic radical having in each case from 1 to 30 carbon atoms; and
the leaving group L⁴ is halogen, alkyloxy having from 1 to 10 carbon atoms or aryloxy having from 6 to 10 carbon atoms.

Tertiary phosphines constitute an important compound class having a variety of possible uses. For example, they are used in the synthesis of phosphine oxides and phosphonium salts. A particularly important application of the tertiary phosphines is their use as a ligand in various catalyst systems, in particular for hydroformylation, carbonylation, hydrogenation and oligomerization.

For the preparation of tertiary phosphines, the prior art discloses various synthetic routes which are described, for instance, in Ullmann's Encyclopedia of Industrial Chemistry, 6^{th} edition, 2000 Electronic Release, Chapter “PHOSPHORUS COMPOUNDS, ORGANIC-Phosphines”. For example, they may be obtained by addition of unsaturated compounds to phosphines (PH₃, or −PH₂ or >PH compounds substituted by organic radicals). Another synthetic route starts from phosphorus chlorides (PCl₃, or −PCl₂ or >PCl compounds substituted by organic radicals), in which they are reacted with a Grignard compound to give the desired phosphine. In a third possible synthesis, the starting materials are likewise phosphorus chlorides as specified above and they are reacted in the presence of a metal as a reducing agent, for example zinc, copper, lithium or sodium, with an organic chlorine compound to give the desired phosphine.

In a fourth synthetic route, which is described in EP-A 0 280 380, WO 99/51614 and W. Wolfsberger et al., Chemiker-Zeitung 115, 1991, page 7 to 13, it is possible to obtain asymmetrically substituted diphenylphosphines of the −P(C₆H₅)₂ type by reacting triphenylphosphine with sodium in liquid ammonia with formation of (C₆H₅)₂PNa and subsequent reaction with an organic chlorine compound to give the desired phosphine.

WO 00/32612 and PCT/EP 04/08497 disclose the synthesis of mono- and bis(acyl)-phosphines by reaction of the corresponding mono- and dihalophosphines with an alkali metal in a solvent and subsequent reaction of the reaction mixture with the corresponding acyl halide. WO 00/32612 teaches the use of ethers, in particular of tetrahydrofuran, and PCT/EP 04/08497 the use of aliphatic and aromatic hydrocarbons and of ethers, in particular of toluene and ethylbenzene, as solvents. In relation to the alkali metal to be used, PCT/EP 04/08497 further teaches that it should be used suspended in the solvent in finely divided form in the molten state with an average particle diameter of ≦500 μm. Such finely divided alkali metal is obtainable, for example, by use of a particularly high-speed stirrer. According to the teaching of PCT/EP 04/08497, the resulting reaction mixture is hydrolyzed with water and the desired mono- or bis(acyl)phosphine is isolated from the organic phase.

DE 2 050 095 describes the preparation of triphenylphosphine by reacting phosphorus trichloride with sodium in an aliphatic, cycloaliphatic or aromatic solvent and chlorobenzene. According to the teaching of DE 2 050 095, the resulting reaction mixture is hydrolyzed with water and triphenylphosphine is isolated from the organic phase.

WO 00/08030 discloses the preparation of asymmetrically substituted phosphines by reaction of an organic phosphine which has a leaving group on the phosphorus, for example an amino, alkoxy or aryloxy group, with an alkali metal in a solvent and subsequent reaction with an organic chlorine compound to give the desired phosphine. Likewise described is also the preparation of diphosphines in which, instead of the organic chlorine compound, an organic dichlorine compound has to be used. According to the teaching of WO 00/08030, the resulting reaction mixture is in each case hydrolyzed with water and the desired asymmetrically substituted phosphine is isolated from the organic phase.

EP-A 0 196 742 discloses the synthesis of alkyldiarylphosphines by reaction of diarylhalophosphine with an alkali metal in a solvent and subsequent reaction with an alkyl chloride to give the desired alkyldiarylphosphine. In relation to the alkali metal to be used, EP-A 0 196 742 teaches that it should be used suspended in the solvent, preferably in the molten state and in finely divided form with an average particle diameter of preferably ≦1000 μm. Suitable solvents are polar solvents, for instance di-n-butyl ether, and nonpolar solvents, for instance toluene. According to the teaching of EP-A 0 196 742, the resulting reaction mixture is hydrolyzed with water and the desired alkyldiarylphosphine is isolated from the organic phase.

U.S. Pat. No. 3,751,481 describes the synthesis of asymmetrically substituted phosphines by reaction of monoaryldihalophosphine or of diarylmonohalophosphine with sodium in a hydrocarbon solvent and subsequent reaction with an organic chlorine compound to give the desired phosphine. In relation to the sodium metal to be used, U.S. Pat. No. 3,751,481 teaches that it should be used suspended in the solvent, preferably in the molten state and in finely divided form with an average particle diameter of preferably ≦1 mm. According to the teaching of U.S. Pat. No. 3,751,481, the resulting reaction mixture is hydrolyzed with water and the desired phosphine is isolated from the organic phase.

A disadvantage of the abovementioned processes is the residual content of elemental alkali metal present in the reaction mixture as a result of its use in excess. Especially in the production of industrial-scale amounts in the range from a few kilograms up to several tons per day, owing to its high reactivity including in the subsequent workup of the reaction mixture, this constitutes a great safety challenge.

It was an object of the present invention to find a process for preparing tertiary phosphines which does not possess the disadvantages of the prior art, has high flexibility with regard to the chemical nature of the tertiary phosphines to be prepared and in particular also permits the preparation of asymmetrically substituted phosphines and of di- and oligophosphines, enables a high yield, high purity and high space-time yield of the desired tertiary phosphines, can be controlled reliably from a safety point of view and also makes it possible to produce industrial scale amounts in the range from a few kilograms up to several tons per day.

Accordingly, a process has been found for preparing tertiary phosphines by reacting a compound of the general formula (I)

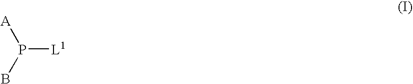

in which
A is R¹ or L²,
B is R² or L³,
the R¹ and R² radicals are each independently an organic radical having in each case from 1 to 30 carbon atoms, where the R¹ and R² radicals may also be joined together; and
the leaving groups L¹ to L³ are each independently halogen, alkyloxy having from 1 to 10 carbon atoms or aryloxy having from 6 to 10 carbon atoms
(a) with an alkali metal in an organic aprotic solvent and
(b) a compound of the general formula (II)

L⁴-R³ (II)

in which
the R³ radical is an organic radical having in each case from 1 to 30 carbon atoms; and
the leaving group L⁴ is halogen, alkyloxy having from 1 to 10 carbon atoms or aryloxy having from 6 to 10 carbon atoms,
   which comprises hydrolyzing the resulting reaction mixture with an aqueous base which has a pH of ≧10, and removing the organic phase from the aqueous phase.

The aqueous base to be used in the process according with the invention preferably has a pH of from 10 to 15, more preferably from 11 to 15, even more preferably from 12 to 15 and in particular from 13 to 15, in each case measured at 25° C. In accordance with the pH ranges specified, the aqueous base to be used has a hydroxide ion concentration of generally ≧0.0001 mol/l, preferably from 0.0001 to 10 mol/l, more preferably from 0.001 to 10 mol/l, even more preferably from 0.01 to 10 mol/l and in particular from 0.1 to 10 mol/l.

The aqueous bases used may in principle be all water-soluble bases which fulfill the criterion mentioned with regard to the pH. Examples of bases which can be used include alkali metal hydroxide solution (alkali metal hydroxides), alkaline earth metal hydroxides, aqueous ammonia, amines, for example methylamine, dimethylamine, trimethylamine, ethylamine, diethylamine and triethylamine, but also basic salts, for instance alkali metal carbonates and alkali metal phosphates. In the process according to the invention, preference is given to using aqueous alkali metal hydroxide solution, more preferably sodium hydroxide solution and potassium hydroxide solution, and most preferably sodium hydroxide solution.

The amount of the aqueous base is generally such that the amount of water present therein is at least sufficient to hydrolyze any excess alkali metal present in the reaction mixture to the alkali metal hydroxide with formation of hydrogen. The amount of the aqueous base is preferably such that the amount of water present therein is additionally also at least sufficient to hydrolyze the by-product salts formed in the reaction, comprising an alkali metal cation and an anion of the [L¹]⁻, [L²]⁻, [L³]⁻ or [L⁴]⁻ type, as long as the anion formed is hydrolyzable in water. The latter is the case, for example, when alkyloxy and aryloxy groups are used as leaving groups, since they lead to the formation of the corresponding alkyloxide and aryloxide anions in the reaction mixture. The amount of the aqueous base is more preferably such that the amount of water present therein is additionally also at least sufficient to keep the originally used base, all hydrolysis products and all soluble by-products dissolved under the existing conditions. In general, the reaction mixture is hydrolyzed exclusively with the aqueous base mentioned.

In general, the aqueous base is therefore used in a volume ratio relative to the reaction mixture of from 0.01 to 100 and preferably from 0.1 to 10.

The elemental alkali metals to be used in the process according to the invention are lithium, sodium, potassium, rubidium, cesium or alloys comprising these alkali metals. Preference is given to using lithium, sodium or potassium and particular preference to using sodium.

Since the accessible surface area of the alkali metal has a significant influence on the startup behavior of the reaction, on the reaction rate and thus also on the space-time yield, generally comminuted alkali metal particles having an average particle size of ≦5 mm are used in the process according to the invention. The average particle size is understood to be the “D50 value” (median value), i.e. the value at which 50% of the total particle volume is present in the form of particles having a diameter greater than this value and 50% of the total particle volume in the form of particles having a diameter smaller than this value. In general, the finer the alkali metal is dispersed in the solvent, the higher the reaction rate. Preference is therefore given to using finely dispersed alkali metal which has an average particle size of ≦500 μm, more preferably of ≦200 μm and most preferably of ≦50 μm. The lower limit is ultimately given by the theoretical atomic distribution of the alkali metal and is thus in the region of an atom diameter in the order of magnitude of 10⁻⁴ μm. The average particle size achievable in practice by rapid stirring with high power input is generally about 1 μm. The average particle size is determined by laser diffraction with preceding setting of an “obscuration” value of about 20%. An example of a suitable measuring instrument is the “Mastersizer 2000” laser diffraction unit from Malvern.

The finely dispersed alkali metal to be used with preference in the process according to the invention may, for example, be obtained in a simple manner by dispersion of the alkali metal in an organic aprotic solvent with the aid of a high-speed stirrer with high power input, for example a propeller stirrer with high power input, with the aid of an Ultraturrax stirrer, a high-speed reaction mixing pump or nozzle spraying. In order to prevent oxidation of the alkali metal, a protective gas atmosphere is employed, preferably a nitrogen atmosphere. The alkali metal may be molten in the solvent or be added already in liquid form. When lithium is used, the temperature is ≧179° C., for example from 179 to 250° C.; when sodium is used, the temperature is ≧97.8° C., for example from 97.8 to 200° C.; and when potassium is used, the temperature is ≧64° C., for example from 64 to 200° C. The resulting dispersion may be converted directly by combining it with the compound (II). However, it may also be cooled to a temperature below the melting point of the alkali metal used and stored intermediately until further processing. The invention includes the recognition that the dispersion, once it has been prepared by melting and dispersion, is stable at temperatures below the melting point of the alkali metal used at least to such an extent that it can be stored intermediately even without further stirring and can be used later in accordance with the invention even without renewed melting and without use of a particularly high-speed stirrer.

In the process according to the invention, the organic aprotic solvent used is preferably
a mono- to hexa-C₁- to C₆-alkyl-substituted benzene, for example toluene, xylenes or ethylbenzene;
an unbranched or branched C₆- to C₁₂-alkane, for example hexane, heptane, octane, nonane, decane, undecane or dodecane;
an unsubstituted or C₁- to C₆-alkyl-substituted C₆- to C₁₂-cycloalkane, for example cyclohexane, cycloheptane or cyclooctane; or
an aliphatic mono- or oligoether having from 4 to 30 carbon atoms,
   having a boiling point under reaction conditions above the melting point of the alkali metal used. Preference is given to ethers of the general formula (III)

R^{a}O—[(CH₂)ₙ—O]ₘ-R^{a} (III)

in which R^{a} is methyl, ethyl, 1-propyl, 1-butyl, 1-pentyl, 1-hexyl or 1-octyl, n is 2 or 4, m is from 0 to 6 and their boiling point under reaction conditions is above the melting point of the alkali metal used. Examples of preferred ethers include di(1-butyl) ether (for Na and K), di(1-pentyl) ether (for Li, Na and K), di(1-hexyl) ether (for Li, Na and K), di(1-octyl) ether (for Li, Na and K), ethylene glycol dimethyl ether (for K), ethylene glycol diethyl ether (for Na and K), diethylene glycol dimethyl ether (for Na and K), diethylene glycol diethyl ether (for Li, Na and K), triethylene glycol dimethyl ether (for Li, Na and K), triethylene glycol diethyl ether (for Li, Na and K), butylene glycol dimethyl ether and butylene glycol diethyl ether. When sodium is used, very particular preference is given to using di(1-butyl) ether.

The volume of the organic aprotic solvent to be used is generally from 5 to 100 times and preferably from 10 to 50 times the theoretical volume of the alkali metal to be used.

The inventive reaction is carried out generally at a temperature of from 50 to 300° C. and preferably in the range from the melting point of the alkali metal used to 250° C. The pressure is generally from 0.01 to 10 MPa abs, preferably from 0.05 to 5 MPa abs, more preferably from 0.095 to 1 MPa abs and in particular from 0.098 to 0.2 MPa abs.

The amount of the alkali metal to be used depends upon the molar amounts of the compounds (I) and (II) to be used and the leaving groups L¹ to L⁴ comprised therein. In general, the theoretical stoichiometry between the alkali metal and the leaving groups is 1:1. The reaction equations for some relevant reactions are reproduced below:

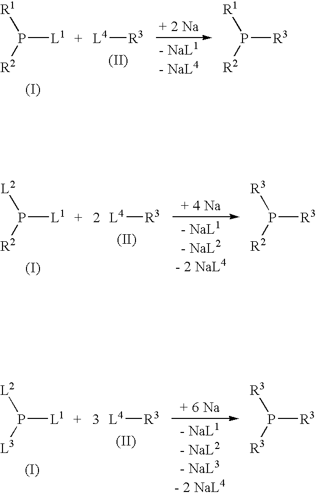

The alkali metal is used in a molar ratio relative to the sum of the leaving groups of the compounds (I) and (II) of preferably from 0.95 to 1.2 and more preferably from 1.0 to 1.1. If R³ itself has still further leaving groups, which is the case, for example, in the preparation of di- and oligophosphines, these leaving groups should likewise be taken into account appropriately.

In the process according to the invention, the compounds (I) and (II) are used in a ratio at which the sum of the leaving groups of the compound (I) to the sum of the leaving groups of the compound (II) is from 0.9 to 1.1 and preferably from 0.98 to 1.02.

Suitable reaction apparatus for carrying out the reaction are in principle all reaction apparatus which are suitable for liquid/liquid reactions, for example stirred tanks or stirred tank batteries. For the preferred preparation of the alkali metal dispersion, it is advantageous to use an apparatus in which an Ultraturrax stirrer can be used, or alternatively, in which the dispersion can be prepared by nozzle spraying.

In the process according to the invention, preference is given to first combining the alkali metal in the organic aprotic solvent with the compound (I) and then combining the resulting mixture with the compound (II). The alkali metal is initially, as already described above, preferably dispersed finely in the solvent. The combination of the alkali metal in the organic aprotic solvent with the compound (I) allows the two components to react together, in the course of which a phosphide is probably formed as an intermediate. In order to promote the reaction in this first stage, the mixture is generally left after the combination for a certain time, for example over a period of a few minutes to several hours, preferably from 5 minutes to 10 hours, at the appropriate reaction temperature. In the second stage, after the reaction mixture of the first stage has been combined with the compound (II), the desired tertiary phosphine is then formed. Particularly intensive mixing, as is needed in the preparation of the alkali metal dispersion and generally also employed in the first stage, is no longer required in the second stage. Typical mixing, as in liquid/liquid reactions, is generally sufficient in the second stage. In order to promote the reaction of the second stage, the reaction mixture is generally left after the combination for a certain time, for example over a period of a few minutes to several hours, preferably from 5 minutes to 10 hours, at the appropriate reaction temperature. Subsequently, the reaction mixture is generally cooled, preferably to a temperature in the range from 20 to 80° C., more preferably from 30 to 50° C., and the cooled reaction mixture is combined with the aqueous base for hydrolysis. This is preferably done with mixing. On completion of hydrolysis, the mixing is generally ended and the two phases are allowed to separate. Depending on the densities, the aqueous phase typically separates at the bottom; the organic phase is typically at the top. The latter is then removed from the aqueous phase. From the removed organic phase, it is then possible if required to obtain the desired tertiary phosphine. To this end, the solvent is generally distilled off, preferably under reduced pressure. In order to obtain the tertiary phosphine in purified form, it is appropriate to subject it to a subsequent purification process. An example of a suitable purification process is recrystallization in a suitable solvent. Suitable solvents for this purpose are, for example, alcohols, for instance methanol, ethanol, propanois or butanols and ethers, for instance THF or diethyl ether.

The process according to the invention may be carried out batchwise or continuously.

When it is carried out continuously:
(a) the alkali metal is dispersed in the organic aprotic solvent in one apparatus;
(b) the dispersion obtained from step (a) is combined with the compound (I) in a further apparatus;
(c) the reaction mixture obtained from step (b) is combined with the compound (II) in a further apparatus;
(d) the reaction mixture obtained from step (c) is combined with aqueous base in a further apparatus; and
(e) the organic phase is removed after the phases have been separated.

It should be pointed out here that the alkali metal dispersion can also be prepared batchwise for the continuous process and can be stored intermediately without any problem by cooling to a temperature below the melting point of the alkali metal used. For example, it is then possible to feed the alkali metal dispersion continuously from a mixed stock vessel.

In step (b), the two components are fed continuously and mixed with one another at the desired reaction temperature. In general, it is advantageous to connect a further apparatus intermediately as a delay vessel between step (b) and (c).

In step (c), the two components are likewise fed continuously and mixed with one another at the desired reaction temperature. In general, it is also advantageous here to connect a further apparatus intermediately as a delay vessel between step (c) and (d).

Step (d) may be carried out either batchwise or continuously. When step (d) is carried out batchwise, it is possible, for example, to feed the reaction stream obtained from step (c) to a mixed apparatus which has been initially charged with the aqueous base until the desired amount has been attained. The biphasic system is then worked up as described under (e). The subsequent reaction stream from step (c) may then, for example, be stored intermediately in an intermediate delay vessel or fed to a second mixed apparatus for hydrolysis.

When step (d) is carried out continuously, it is possible, for example, to feed the reaction stream obtained from step (c) together with the aqueous base continuously to a mixed apparatus which has been initially charged with the aqueous base. From this apparatus, the biphasic suspension may be fed continuously to a phase separation apparatus, for example via an overflow, or alternatively also via an upper and lower overflow, and the upper and lower phase may be removed continuously therefrom for further workup.

In formula (I), the R¹ and R² radicals are each independently an organic radical having in each case from 1 to 30 carbon atoms, where the R¹ and R² radicals may also be joined together. In formula (II), the R³ radical is an organic radical having in each case from 1 to 30 carbon atoms.

In this context, an organic radical having from 1 to 30 carbon atoms is understood to be a carbon-comprising organic, saturated or unsaturated, acyclic or cyclic, aliphatic, aromatic or araliphatic radical which is unsubstituted or is interrupted or substituted by from 1 to 5 heteroatoms or functional groups and has from 1 to 30 carbon atoms.

Possible heteroatoms in the definition of the R¹ to R³ and L¹ to L⁴ radicals are in principle all heteroatoms which are capable in a formal sense of replacing a —CH₂—, a —CH═, a —C≡ or a —C— group. When the carbon-comprising radical comprises heteroatoms, preference is given to oxygen, nitrogen, sulfur, phosphorus and silicon. Preferred groups include in particular —O—, —S—, —SO—, —SO₂—, —NR′—, —N═, —PR′—, —PR′₂ and —SiR′₂—, where the R′ radicals are the remaining portion of the carbon-comprising radical.

Possible functional groups in the definition of the R¹ to R³ and L¹ to L⁴ radicals are in principle all functional groups which can be bonded to a carbon atom or a heteroatom. Suitable examples include ═O (in particular as a carbonyl group). Functional groups and heteroatoms may also be directly adjacent, so that combinations of a plurality of adjacent atoms, for instance —O— (ether), —S— (thioether), —COO— (ester) or —CONR′— (tertiary amide), are also included.

The R¹ and R² radicals are preferably each independently
unbranched or branched C₁- to C₃₀-alkyl, preferably C₁- to C₂₀-alkyl, which is optionally substituted by functional groups, aryl, alkyl, aryloxy, alkyloxy, halogen, heteroatoms and/or heterocycles, and/or interrupted by one or more oxygen and/or sulfur atoms;
C₆- to C₁₂-aryl which is optionally substituted by functional groups, aryl, alkyl, aryloxy, alkyloxy, halogen, heteroatoms and/or heterocycles;
C₅- to C₁₂-cycloalkyl which is optionally substituted by functional groups, aryl, alkyl, aryloxy, alkyloxy, halogen, heteroatoms and/or heterocycles;
unbranched or branched C₁- to C₃₀-alkyloxy, preferably C₁- to C₂₀-alkyloxy, which is optionally substituted by functional groups, aryl, alkyl, aryloxy, alkyloxy, halogen, heteroatoms and/or heterocycles, and/or interrupted by one or more oxygen and/or sulfur atoms;
C₆- to C₁₂-aryloxy which is optionally substituted by functional groups, aryl, alkyl, aryloxy, alkyloxy, halogen, heteroatoms and/or heterocycles;
C₅- to C₁₂-cycloalkyloxy which is optionally substituted by functional groups, aryl, alkyl, aryloxy, alkyloxy, halogen, heteroatoms and/or heterocycles; or
a five- to six-membered heterocycle which has oxygen, nitrogen and/or sulfur atoms and is optionally substituted by functional groups, aryl, alkyl, aryloxy, alkyloxy, halogen, heteroatoms and/or heterocycles;
   or, if they are joined to one another,
an unsaturated, saturated or aromatic ring which has from 4 to 8 atoms in the ring chain and a total of from 4 to 50 carbon atoms in the entire diradical radical, is optionally substituted by functional groups, aryl, alkyl, aryloxy, alkyloxy, halogen, heteroatoms and/or heterocycles and is optionally interrupted by one of more oxygen and/or sulfur atoms.

C₁- to C₃₀-alkyl which is optionally substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, 1-phenylethyl, 2-phenylethyl, 3-phenypropyl, α,α-dimethylbenzyl, p-tolylmethyl or 1-(p-butylphenyl)ethyl.

C₆- to C₁₂-aryl which is optionally substituted by functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, methylphenyl, dimethylphenyl, trimethylphenyl, ethylphenyl, diethylphenyl, isopropylphenyl, tert-butylphenyl, dodecylphenyl, methylnaphthyl, isopropylnaphthyl, 2,6-dimethylphenyl or 2,4,6-trimethylphenyl.

C₅- to C₁₂-cycloalkyl which is optionally substituted by functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, and also a saturated or unsaturated bicyclic system, for example norbornyl or norbornenyl.

Unbranched or branched C₁- to C₃₀-alkyloxy, preferably C₁- to C₂₀-alkyloxy, which is optionally substituted by functional groups, aryl, alkyl, aryloxy, alkyloxy, halogen, heteroatoms and/or heterocycles and/or interrupted by one or more oxygen and/or sulfur atoms is preferably methyloxy, ethyloxy, 1-propyloxy, 1-butyloxy, 1-pentyloxy or 1-hexyloxy.

C₆- to C₁₂-aryloxy which is optionally substituted by functional groups, aryl, alkyl, aryloxy, alkyloxy, halogen, heteroatoms and/or heterocycles is preferably phenyloxy.

C₅- to C₁₂-cycloalkyloxy which is optionally substituted by functional groups, aryl, alkyl, aryloxy, alkyloxy, halogen, heteroatoms and/or heterocycles is preferably cyclopentyloxy, cyclohexyloxy or cyclooctyloxy.

A five- to six-membered heterocycle which has oxygen, nitrogen and/or sulfur atoms and is optionally substituted by functional groups, aryl, alkyl, aryloxy, alkyloxy, halogen, heteroatoms and/or heterocycles, is preferably furyl, thiophenyl, pyrryl, pyridyl, indolyl, imidazolyl, benzoxazolyl, dioxolyl, dioxyl, benzimidazolyl, benzothiazolyl, dimethylpyridyl, methylquinolyl, dimethylpyrryl, methoxyfuryl, dimethoxypyridyl or difluoropyridyl.

When the R¹ and R² radicals are joined together, they are preferably 1,4-butylene, 1,5-pentylene, 1,6-hexylene, 1,8-octylene, 3-oxa-1,5-pentylene, 1,4-buta-1,3-dienylene or 2,2′-biphenylene.

The R¹ and R² radicals are more preferably each independently C₁- to C₂₀-alkyl, C₇- to C₂₀-arylalkyl, C₆- to C₁₀-aryl, C₇- to C₁₄-alkylaryl, C₅- to C₁₂-cycloalkyl, C₆- to C₁₂-alkylcycloalkyl, C1- to C₂₀-alkyloxy, C₆- to C₁₂-aryloxy, C₇- to C₁₄-alkylaryloxy, C₅- to C₁₂-cycloalkyloxy and C₅- to C₁₂-alkylcycloalkyloxy. Particularly preferred radicals include methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-ethyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, phenyl, o-tolyl, m-tolyl, p-tolyl, 2,3-xylyl, 2,4-xylyl, 2,5-xylyl, 2,6-xylyl, 3,4-xylyl, 3,5-xylyl, α-naphthyl, β-naphthyl, cyclopentyl, cyclohexyl, cyclooctyl, methyloxy, ethyloxy, 1-propyloxy, 1-butyloxy, phenyloxy, cyclopentyloxy, cyclohexyloxy and cyclooctyloxy.

The R¹ and R² radicals are most preferably phenyl.

In formula (I), the leaving groups L¹ to L³ are each independently halogen, alkyloxy having from 1 to 10 carbon atoms or aryloxy having from 6 to 10 carbon atoms.

Halogens include fluorine, chlorine, bromine and iodine.

The leaving groups L¹ to L³ are preferably each independently
chlorine or bromine;
unbranched or branched C₁- to C₁₀-alkyloxy, preferably C₁- to C₆-alkyloxy, which is optionally substituted by functional groups, aryl, alkyl, aryloxy, alkyloxy, halogen, heteroatoms and/or heterocycles, and/or interrupted by one or more oxygen and/or sulfur atoms; or
C₆- to C₁₀-aryloxy which is optionally substituted by functional groups, aryl, alkyl, aryloxy, alkyloxy, halogen, heteroatoms and/or heterocycles.

Unbranched or branched C₁- to C₁₀-alkyloxy which is optionally substituted by functional groups, aryl, alkyl, aryloxy, alkyloxy, halogen, heteroatoms and/or heterocycles, and/or interrupted by one or more oxygen and/or sulfur atoms is preferably methyloxy, ethyloxy, 1-propyloxy, 1-butyloxy, 1-pentyloxy or 1-hexyloxy.

C₆- to C₁₀-Aryloxy which is optionally substituted by functional groups, aryl, alkyl, aryloxy, alkyloxy, halogen, heteroatoms and/or heterocycles is preferably phenyloxy.

The leaving groups L¹ to L³ are more preferably each independently chlorine, bromine, methyloxy, ethyloxy and phenyloxy, in particular chlorine.

The compound (I) to be used in the process according to the invention is specifically compounds of the general formulae (Ia) to (Ic)

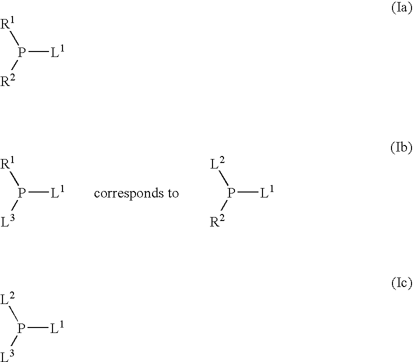

In accordance with the particularly preferred R¹ and R² radicals and the leaving groups L¹ to L³, the compound (I) used in the process according to the invention is more preferably diphenylchlorophosphine, diphenylbromophosphine, diphenylmethoxyphosphine, diphenylethoxyphosphine, diphenylphenoxyphosphine, phenyldichlorophosphine, phenyldibromophosphine, phenyidimethoxyphosphine, phenyidiethoxyphosphine, phenyidiphenoxyphosphine, trichlorophosphine (phosphorus trichloride) and tribromophosphine (phosphorus tribromide).

In formula (II), the R³ radical represents an organic radical having in each case from 1 to 30 carbon atoms. With regard to the term “organic radical having in each case from 1 to 30 carbon atoms”, reference is made to the definition already given above.

The R³ radical is preferably
unbranched or branched C₁- to C₃₀-alkyl, preferably C₁- to C₂₀-alkyl, which is optionally substituted by functional groups, aryl, alkyl, aryloxy, alkyloxy, halogen, heteroatoms and/or heterocycles, and/or interrupted by one or more oxygen and/or sulfur atoms;
C₆- to C₁₂-aryl which is optionally substituted by functional groups, aryl, alkyl, aryloxy, alkyloxy, halogen, heteroatoms and/or heterocycles; or
C₅- to C₁₂-cycloalkyl which is optionally substituted by functional groups, aryl, alkyl, aryloxy, alkyloxy, halogen, heteroatoms and/or heterocycles.

When the tertiary phosphines prepared in the process according to the invention are to be di- and oligophosphines, the R³ radical preferably additionally comprises one or more leaving groups of the L⁴ type.

C₁- to C₃₀-Alkyl which is optionally substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, chloromethyl, 2-chloroethyl, 3-chloropropyl, 4-chlorobutyl, 5-chloropentyl, 6-chlorohexyl, bromomethyl, 2-bromoethyl, 3-bromopropyl, 4-bromobutyl, 5-bromopentyl, 6-bromohexyl, 3-chloro-2,2-dimethylpropyl, 3-bromo-2,2-dimethylpropyl, 3-chloro-2-methyl-2-chloromethylpropyl, 3-bromo-2-methyl-2-bromomethylpropyl, 3-chloro-2-ethyl-2-chloromethylpropyl, 3-bromo-2-ethyl-2-bromomethylpropyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, methyl, 1-phenylethyl, 2-phenylethyl, 3-phenylpropyl, 2-chloromethylphenylmethyl, 2-bromomethylphenylmethyl, 3-chloromethylphenylmethyl, 3-bromomethylphenylmethyl, 4-chloromethylphenylmethyl, 4-bromomethylphenylmethyl, α,α-dimethylbenzyl, p-tolylmethyl or 1-(p-butylphenyl)ethyl. In addition, the generic term mentioned, owing to its definition (“optionally substituted by functional groups”), in the case that the first carbon atom bears an ═O group, also comprises C₁- to C₃₀-acyl radicals which are optionally substituted by functional groups, aryl, alkyl, aryloxy, alkyloxy, halogen, heteroatoms and/or heterocycles, for example acetyl, benzoyl or 2,4,6-trimethylbenzoyl.

C₆- to C₁₂-aryl which is optionally substituted by functional groups, aryl, alkyl, aryloxy, alkyloxy, halogen, heteroatoms and/or heterocycles is preferably phenyl, tolyl, xylyl, α-naphthyl, β-naphthyl, 4-diphenylyl, methylphenyl, dimethylphenyl, trimethylphenyl, ethylphenyl, diethylphenyl, iso-propylphenyl, tert-butylphenyl, dodecylphenyl, 2-chlorophenyl, 2-bromophenyl, 3-chlorophenyl, 3-bromophenyl, 4-chlorophenyl, 4-bromophenyl, methyinaphthyl, isopropylnaphthyl, 2,6-dimethylphenyl or 2,4,6-trimethylphenyl.

C₅- to C₁₂-cycloalkyl which is optionally substituted by functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, and also a saturated or unsaturated bicyclic system, for example norbornyl or norbornenyl.

The R³ radical is more preferably C₁- to C₂₀-alkyl, C₇- to C₂₀-arylalkyl, C₆- to C₁₀-aryl, C₇- to C₁₄-alkylaryl, C₅- to C₁₂-cycloalkyl, C₆- to C₁₂-alkylcycloalkyl or their mono- or poly-chlorine-, -bromine-, -methyloxy-, -ethyloxy- or -phenyloxy-substituted derivatives. Particularly preferred radicals include phenyl, chloromethyl, 2-chloroethyl, 3-chloropropyl, 4-chlorobutyl, 5-chloropentyl, 6-chlorohexyl, bromomethyl, 2-bromoethyl, 3-bromopropyl, 4-bromobutyl, 5-bromopentyl, 6-bromohexyl, 3-chloro-2,2-dimethylpropyl, 3-bromo-2,2-dimethylpropyl, 3-chloro-2-methyl-2-chloromethylpropyl, 3-bromo-methyl-2-bromomethylpropyl, 3-chloro-2-ethyl-2-chloromethylpropyl, 3-bromo-2-ethyl2-bromomethylpropyl, 2-chlorophenyl, 2-bromophenyl, 3-chlorophenyl, 3-bromophenyl, 4-chlorophenyl, 4-bromophenyl, 2-chloromethylphenylmethyl, 2-bromomethylphenylmethyl, 3-chloromethylphenylmethyl, 3-bromomethylphenylmethyl, 4-chloromethylphenylmethyl, 4-bromomethylphenylmethyl, and very particularly preferred radicals include 3-chloropropyl, 3-bromopropyl, 3-chloro-2-methyl-2-chloromethylpropyl, 3-chloro-2-ethyl-2-chloromethylpropyl and 3-chloro-2,2-dimethylpropyl.

In formula (II), the leaving group L⁴ is halogen, alkyloxy having from 1 to 10 carbon atoms or aryloxy having from 6 to 10 carbon atoms.

Halogens include fluorine, chlorine, bromine and iodine.

The leaving group L⁴ is preferably
chlorine or bromine;
unbranched or branched C₁- to C₁₀-alkyloxy, preferably C₁- to C₆-alkyloxy, which is optionally substituted by functional groups, aryl, alkyl, aryloxy, alkyloxy, halogen, heteroatoms and/or heterocycles, and/or interrupted by one or more oxygen and/or sulfur atoms; or
C₆- to C₁₀-aryloxy which is optionally substituted by functional groups, aryl, alkyl, aryloxy, alkyloxy, halogen, heteroatoms and/or heterocycles.

Unbranched or branched C₁- to C₁₀-alkyloxy which is optionally substituted by functional groups, aryl, alkyl, aryloxy, alkyloxy, halogen, heteroatoms and/or heterocycles, and/or interrupted by one or more oxygen and/or sulfur atoms is preferably methyloxy, ethyloxy, 1-propyloxy, 1-butyloxy, 1-pentyloxy or 1-hexyloxy.

C₆- to C₁₀-Aryloxy which is optionally substituted by functional groups, aryl, alkyl, aryloxy, alkyloxy, halogen, heteroatoms and/or heterocycles is preferably phenyloxy.

The leaving group L⁴ is more preferably chlorine, bromine, methyloxy, ethyloxy and phenyloxy, in particular chlorine.

In accordance with the particularly preferred R³ radical and the particularly preferred leaving group L⁴, the compound (II) used in the process according to the invention is more preferably chlorobenzene, dichloromethane, dibromomethane, 1,2-dichloroethane, 1,2-dibromoethane, 1,3-dichloropropane, 1,3-dibromopropane, 1,3- bromochloropropane, 1,4-dichlorobutane, 1,4-dibromobutane, 1,5-dichloropentane, 1,5-dibromopentane, 1,6-dichlorohexane, 1,6-dibromohexane, 1,3-dichloro-2,2-dimethylpropane, 1,3-dibromo-2,2-dimethylpropane, 1,3-dichloro-2-methyl-2-chloromethylpropane, 1,3-dibromo-2-methyl-2-bromomethylpropane, 1,3-dichloro-2-ethyl-2-chloromethylpropane, 1,3-dibromo-2-ethyl-2-bromomethylpropane, 1,2-dichlorobenzene, 1,2-dibromobenzene, 1,3-dichlorobenzene, 1,3-dibromobenzene, 1,4-dichlorobenzene, 1,4-dibromobenzene, 1,2-bis(chloromethyl)benzene, 1,2-bis(bromomethyl)benzene, 1,3-bis(chloromethyl)benzene, 1,3-bis(bromomethyl)-benzene, 1,4-bis(chloromethyl)benzene and 1,4-bis(bromomethyl)benzene.

In the process according to the invention, the compound (II) used is most preferably 1,3-bromochloropropane, 1,3-dichloro-2-methyl-2-chloromethylpropane, 1,3-dichloro-2-ethyl-2-chloromethylpropane and 1,3-dichloro-2,2-dimethylpropane.

In the process according to the invention, preference is given to preparing tertiary mono-, di-, tri- and tetraphosphines, and particular preference to preparing mono-, di- and triphosphines.

In a preferred embodiment for the batchwise preparation of tertiary phosphines, the desired amount of sodium is dispersed under protective gas in the desired amount of an aprotic organic solvent of the general formula (III) by heating to a temperature above the melting point of sodium and intensive mixing with the aid of an Ultraturrax stirrer. The compound (I) is then added slowly to this intensively mixed dispersion which is subsequently stirred further for a certain time. The compound (II) is then added slowly with further intensive mixing and the mixture is likewise stirred further for a certain time. The resulting reaction mixture is then added slowly with stirring to prepared sodium hydroxide solution which has an original pH of ≧10. After the hydrolysis, the two phases are allowed to separate from one another and the upper, organic phase is removed. From this phase, the volatile components (especially the solvent (III) used) are then distilled off under reduced pressure and the desired tertiary phosphine is obtained from the resulting crude product, for example by recrystallization.

In a preferred embodiment for the continuous preparation of tertiary phosphines, the desired amount of sodium is dispersed under protective gas in the desired amount of an aprotic organic solvent of the general formula (III) by heating to a temperature above the melting point of sodium and intensive mixing with the aid of a stirrer with high power input. If present, the alkali metal may be introduced already in liquid form into the solvent heated to the desired temperature with intensive stirring. If required, it is possible to cool the dispersion to a temperature below the melting point of sodium, and, for example, to store it intermediately in a stock vessel. The sodium dispersion, freshly prepared or intermediately stored, is then fed together with the compound (I) continuously to a further apparatus and mixed intensively. The overflow of this apparatus is transferred continuously into a delay vessel and fed from there together with the compound (II) continuously to a further apparatus and mixed intensively. The overflow of this apparatus is transferred continuously into a delay vessel and fed from there continuously to a further apparatus for hydrolysis with sodium hydroxide solution which has an original pH of ≧10. As already described, the hydrolysis may be effected either batchwise or continuously. After the hydrolysis, the two phases are allowed to separate from one another and the upper, organic phase is removed. From this phase, the volatile components (especially the solvent (III) used) are then distilled off under reduced pressure and the desired tertiary phosphine is obtained from the resulting crude product, for example by recrystallization.

The process according to the invention enables the preparation of tertiary phosphines, which has a high flexibility with regard to the chemical nature of the tertiary phosphines to be prepared and in particular also permits the preparation of asymmetrically substituted phosphines and also of di- and oligophosphines, enables a high yield, high purity and high space-time yield of the desired tertiary phosphines, can be controlled reliably from a safety point of view and also makes possible the production of industrial scale amounts in the range from a few kilograms up to several tons per day. The inventive hydrolysis with an aqueous base which has a pH of ≧10 measured at 25° C. distinctly reduces the exothermicity of the hydrolysis and thus distinctly decreases the risk of uncontrolled hydrogen evolution and of local overheating with the consequence of uncontrolled boiling delay. In addition, the process according to the invention may also be performed without addition of activators or stabilizers.

### EXAMPLES

### Example 1

### Batchwise Preparation of 1,3-bis(diphenylphosphino)propane

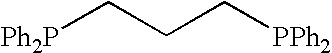

A 2.5 l stirred tank was initially charged under a nitrogen atmosphere with 90.6 g (3.94 mol) of sodium in 1800 ml of di(1-butyl) ether, and the mixture was heated to 105° C. and dispersed with an Ultraturrax stirrer at 4000 rpm for 15 minutes, so that the average sodium particle size was ≦200 μm. Subsequently, with further stirring with the Ultraturrax stirrer, 373 g (1.79 mol) of liquid diphenylchlorophosphine were added within one hour and the mixture was stirred at 105° C. for a further hour. Thereafter, 141.0 g (896 mmol) of 1,3-bromochloropropane were added dropwise within one hour and the mixture was stirred further at 105° C. for a further hour. The mixture was then cooled to room temperature and the resulting suspension was introduced for hydrolysis in 1200 ml of 10% by weight (2.5 mol/l) sodium hydroxide solution. After the phases had been separated, the upper, organic phase was removed and the solvent was distilled off under reduced pressure. The oily crude product was finally recrystallized in ethanol. 351 g of product were obtained. A ¹H NMR and ³¹P NMR spectroscopy analysis and GC analysis confirmed that 1,3-bis(diphenylphosphino)propane had been obtained in >98% purity. This gives a yield of 95%. The melting point of the resulting crystals was 60-63° C.

### Example 2

### Batchwise Preparation of 1,1,1-tris(diphenylphosphinomethyl)ethane

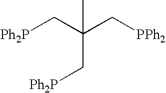

A 500 ml round-bottom flask was initially charged under a nitrogen atmosphere with 13.7 g (590 mmol) of sodium in 180 ml of di(1-butyl) ether, and the mixture was heated to 105° C. and dispersed with an Ultraturrax stirrer at 13 500 rpm for 15 minutes, so that the average sodium particle size was ≦200 μm. Subsequently, with further stirring with the Ultraturrax stirrer, 59.6 g (270 mmol) of liquid diphenylchlorophosphine were added within one hour and the mixture was stirred at 105° C. for a further hour. Thereafter, 15.8 g (90.0 mmol) of 1,3-dichloro-2-(chloromethyl)-2-methylpropane were added dropwise within one hour and the mixture was stirred further at 105° C. for a further hour. The mixture was then cooled to room temperature and the resulting suspension was introduced for hydrolysis in 150 ml of 10% by weight (2.5 mol/l) sodium hydroxide solution. After the phases had been separated, the upper, organic phase was removed and the solvent was distilled off under reduced pressure. The oily crude product was finally recrystallized in ethanol. 56.2 g of product were obtained. A ¹H NMR and ³¹P NMR spectroscopy analysis confirmed that 1-tris(diphenylphosphinomethyl)ethane had been obtained in >98% purity. This gives a yield of 87%. The melting point of the resulting crystals was 98° C.

### Example 3

### Batchwise Preparation of 1,1,1-tris(diphenylphosphinomethyl)propane

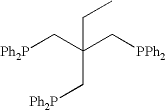

A 1000 ml round-bottom flask was initially charged under a nitrogen atmosphere with 17.4 g (758 mmol) of sodium in 330 ml of di(1-butyl) ether, and the mixture was heated to 105° C. and dispersed with an Ultraturrax stirrer at 17 500 rpm for 15 minutes, so that the average sodium particle size was ≦200 pm. Subsequently, with further stirring with the Ultraturrax stirrer, 75.26 g (341 mmol) of liquid diphenylchlorophosphine were added within one hour and the mixture was stirred at 105° C. for a further hour. Thereafter, 21.57 g (114 mmol) of 1,3-dichloro-2-ethyl-2-chloromethylpropane dissolved in 50 ml of di(1-butyl) ether were added dropwise within one hour and the mixture was stirred further at 105° C. for a further hour. The mixture was then cooled to room temperature and the resulting suspension was introduced for hydrolysis in 330 ml of 10% by weight (2.5 mol/l) sodium hydroxide solution. After the phases had been separated, the upper, organic phase was removed and the solvent was distilled off under reduced pressure. The oily crude product was finally recrystallized in ethanol. 56.8 g of product were obtained. A ¹H NMR and ³¹P NMR spectroscopy analysis confirmed that 1-tris(diphenylphosphinomethyl)propane had been obtained in >98% purity. This gives a yield of 78%. The melting point of the resulting crystals was 99-100° C.

### Example 4

### Continuous Preparation of 1,3-bis(diphenylphosphino)-2,2-dimethylpropane

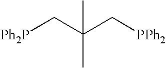

A 250 ml stirred tank was supplied under a nitrogen atmosphere with 120 g/h (5.22 mol/h) of liquid sodium in 3074 g/h of di(1-butyl) ether at 130° C., which was dispersed with an Ultraturrax stirrer at 11 000 rpm, so that the average sodium particle size was ≦200 μm. The suspension was conveyed via an overflow continuously into a 2.5 l stirred tank in which 519 g/h (2.35 mol/h) of diphenylchlorophosphine were metered at 130° C. with stirring at from 600 to 1000 rpm. From this stirred tank, the mixture was likewise conveyed via an overflow continuously into a 750 ml stirred tank in which 165 g/h (1.17 mol/h) of 1,3-dichloro-2,2-dimethylpropane were metered at 130° C. with stirring at from 800 to 1200 rpm. The resulting reaction mixture was conveyed continuously into a 750 ml postreactor which was operated at 90° C. From there, the reaction mixture was conveyed continuously into a downstream vessel and cooled therein to room temperature. The reaction mixture collected in the downstream vessel was then hydrolyzed batchwise in 10% by weight (2.5 mol/l) sodium hydroxide solution, the volume of the aqueous sodium hydroxide solution used having corresponded to the volume of the di(1-butyl) ether used. After the phases had been separated, the upper, organic phase was removed and the solvent was distilled off under reduced pressure. The oily crude product was subsequently recrystallized in methanol. 515 g/h of product were obtained. A ¹H NMR and ³¹P NMR spectroscopy analysis confirmed that 1,3-bis(diphenylphosphino)-2,2-dimethylpropane had been obtained in >98% purity. This gives a yield of 85%. The melting point of the resulting crystals was 90° C.

1. A process for preparing tertiary phosphines by reacting a compound of the general formula (I) 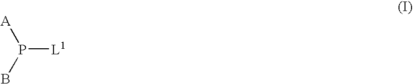
in which
A is R¹ or L²,
B is R² or L³,
the R¹ and R² radicals are each independently an organic radical having in each case from 1 to 30 carbon atoms, where the R¹ and R² radicals may also be joined together; and
the leaving groups L¹ to L³ are each independently halogen, alkyloxy having from 1 to 10 carbon atoms or aryloxy having from 6 to 10 carbon atoms
(a) with an alkali metal in an organic aprotic solvent and
(b) a compound of the general formula (II)
L⁴-R³ (II)
in which
the R³ radical is an organic radical having in each case from 1 to 30 carbon atoms; and
the leaving group L⁴ is halogen, alkyloxy having from 1 to 10 carbon atoms or aryloxy having from 6 to 10 carbon atoms,
which comprises first combining the alkali metal in the organic aprotic solvent with the compound (I) and then the resulting mixture with the compound (II), and hydrolyzing the resulting reaction mixture with an aqueous base which has a pH of ≧10, and removing the organic phase from the aqueous phase.

2. The process according to claim 1, wherein an aqueous base is used which has a pH of from 10 to 15 measured at 25° C.

3. The process according to claim 1, wherein the aqueous base used is an aqueous alkali metal hydroxide solution.

4. The process according to claim 1, wherein the aqueous base is used in a volume ratio relative to the reaction mixture of from 0.01 to 100.

5. The process according to claim 1, wherein the alkali metal used is lithium, sodium or potassium.

6. The process according to claim 1, wherein finely dispersed alkali metal which has an average particle size of ≦500 μm is used.

7. The process according to claim 1, wherein the organic aprotic solvent used is an aliphatic mono- or oligoether having from 4 to 30 carbon atoms and a boiling point under reaction conditions above the melting point of the alkali metal used.

8. The process according to claim 1, wherein the reaction is carried out at a temperature in the range from the melting point of the alkali metal used to 250° C.

9. The process according to claim 1, wherein the reaction is carried out at a pressure of from 0.05 to 5 MPa abs.

10. The process according to claim 1, wherein the alkali metal is used in a molar ratio relative to the sum of the leaving groups of the compounds (II) and (III) of from 0.95 to 1.2.

11. The process according to claim 1, wherein the compounds (I) and (II) are used in a ratio at which the sum of the leaving groups of the compound (I) to the sum of the leaving groups of the compound (II) is from 0.9 to 1.1.

12. The process according to claim 1, which is carried out continuously.

13. The process according to claim 12, wherein
(a) the alkali metal is dispersed in the organic aprotic solvent in one apparatus;
(b) the dispersion obtained from (a) is combined with the compound (I) in a further apparatus to produce a first reaction mixture;
(c) the first reaction mixture obtained from (b) is combined with the compound (II) in a further apparatus to produce a second reaction mixture;
(d) the second reaction mixture obtained from (c) is combined with an aqueous base in a further apparatus to produce an organic phase and an aqueous phase; and
(e) the organic phase is removed after the phases have been separated.

14. The process according to claim 1, wherein the R¹ and R² radicals used are each independently C₁- to C₂₀-alkyl, C₇- to C₂₀-aryl-alkyl, C₆- to C₁₀-aryl, C₇- to C₁₄-alkylaryl, C₅- to C₁₂-cycloalkyl, C₆- to C₁₂-alkylcycloalkyl, C₁- to C₂₀-alkyloxy, C₆- to C₁₂-aryloxy, C₇- to C₁₄-alkylaryloxy, C₅- to C₁₂-cycloalkyloxy or C₅- to C₁₂-alkylcycloalkyloxy.

15. The process according to claim 1, wherein the leaving groups L¹ to L³ used are each independently chlorine, bromine, methyloxy, ethyloxy or phenyloxy.

16. The process according to claim 1, wherein the R³ radical used is C₁- to C₂₀-alkyl, C₇- to C₂₀-arylalkyl, C₆- to C₁₀-aryl, C₇- to C₁₄-alkylaryl, C₅- to C₁₂-cycloalkyl, C₆- to C₁₂-alkylcycloalkyl or their mono- or poly-chlorine-, -bromine-, -methyloxy-, -ethyloxy- or -phenyloxy-substituted derivatives.

17. The process according to claim 1, wherein the leaving group L⁴ used is chlorine, bromine, methyloxy, ethyloxy or phenyloxy.
